(19) United States
(12) Patent Application Publication
(10) Pub. No.: US 2024/0408927 A1
(43) Pub. Date: Dec. 12, 2024

(54) SUSPENSION DAMPING FORCE CONTROL SYSTEM AND METHOD

(71) Applicant: JAGUAR LAND ROVER LIMITED, Whitley, Coventry, Warwickshire (GB)

(72) Inventors: David RUIZ DIEZ, Whitley, Coventry, Warwickshire (GB); Connor BARCLAY, Whitley, Coventry, Warwickshire (GB); Robert NEILSON, Whitley, Coventry, Warwickshire (GB)

(21) Appl. No.: 18/702,642

(22) PCT Filed: Oct. 11, 2022
(86) PCT No.: PCT/EP2022/078286

§ 371 Date: Apr. 18, 2024

(30) Foreign Application Priority Data
Oct. 22, 2021 (GB) 2115211.1

(51) Int. Cl. B60G 17/0165; B60G 17/019

(52) U.S. Cl. CPC B60G 17/0165; B60G 17/01933; B60G 2204/62; B60G 2400/204; B60G 2400/252; B60G 2500/00; B60G 2600/182; B60G 2800/162; B60G 2800/915

(57) ABSTRACT

A control system configured to control a damping force of an actuator of an active suspension system of a vehicle in response to an external disturbance of a wheel with which the actuator is associated, includes one or more controllers and configured to: receive a sensed displacement parameter indicative of suspension displacement associated with the wheel; determine whether a condition is satisfied, wherein satisfaction of the condition requires the sensed displacement parameter to indicate a transition from a suspension displacing phase associated with the external disturbance to a suspension restoring phase associated with the external disturbance, and wherein satisfaction of the condition depends on an amount of suspension displacement indicated by the sensed displacement parameter; and output a signal to control the damping force to be greater, during the suspension restoring phase associated with the external disturbance, than if the condition is not satisfied, in dependence on satisfaction of the condition.

### TECHNICAL FIELD

The present disclosure relates to a suspension damping force control system and method. In particular, but not exclusively it relates to a trigger condition of the method.

### BACKGROUND

Active suspension systems include adaptive suspension systems or fully active suspension systems (FAS).

Adaptive suspension systems vary the damping force (firmness) of an actuator (damper, shock absorber).

Fully active suspension systems use a type of actuator that can control damping force and additionally raise and lower the vehicle body independently at each wheel.

Adaptive suspension systems generally use sensors that measure body or wheel motions as they react to the road/driver inputs. However, most sensors cannot robustly predict the road profile ahead of the vehicle. This means that for a large external disturbance (road inputs) of a wheel that results in a durability event for the vehicle, the adaptive suspension system cannot react quickly enough to effectively control the event.

### SUMMARY OF THE INVENTION

It is an aim of the present invention to address one or more of the disadvantages associated with the prior art.

Aspects and embodiments of the invention provide a control system, an active suspension system, a vehicle, a method, and computer software as claimed in the appended claims.

According to an aspect of the invention there is provided a control system configured to control a damping force of an actuator of an active suspension system of a vehicle in response to an external disturbance of a wheel with which the actuator is associated, the control system comprising one or more controllers, wherein the control system is configured to:
receive a sensed displacement parameter indicative of suspension displacement associated with the wheel;
determine whether a condition is satisfied, wherein satisfaction of the condition requires the sensed displacement parameter to indicate a transition from a suspension displacing phase associated with the external disturbance to a suspension restoring phase associated with the external disturbance, and wherein satisfaction of the condition depends on an amount of suspension displacement indicated by the sensed displacement parameter; and
output a signal to control the damping force to be greater, during the suspension restoring phase associated with the external disturbance, than if the condition is not satisfied, in dependence on satisfaction of the condition.

An advantage is enabling increased balance between comfort and vehicle durability, because this ‘trigger’ condition is a function of the amount of displacement. It is easier to detect when a suspension event is not a durability event, so the suspension can remain in a comfortable setting for longer.

Detecting the transition may be dependent on a change of sign of a derivative of the sensed displacement parameter from a first sign associated with the suspension displacing phase to a second sign associated with the suspension restoring phase. Detecting the transition may be dependent on the derivative, having the second sign, being greater than a threshold.

An advantage is enabling an increased balance between comfort and vehicle durability, because the condition can be a function of both the amount of displacement and its derivative thereof.

The threshold may depend on the amount of suspension displacement indicated by the sensed displacement parameter. The threshold may decrease as the amount of suspension displacement indicated by the sensed displacement parameter increases. The threshold may fall to less than or equal to one metre per second by a value of the amount of suspension displacement selected from the range approximately 20% to approximately 60% of a bump stop or full droop value.

An advantage is enabling an improved balance between comfort and durability because non-durability events can be ignored.

The threshold may be further dependent on whether the second sign is positive or negative, such that for at least some values of the amount of suspension displacement the threshold is lower if the second sign indicates a suspension compression direction than if the sign indicates a suspension extension direction.

An advantage is enabling an improved balance between comfort and durability because the control system can distinguish between rebound before compression (which is less energetic) and compression before rebound (which is more energetic).

The condition may require the threshold to be exceeded multiple times within a sampling window.

The control system may be configured to determine whether a pre-trigger condition is satisfied, during the suspension displacing phase, wherein satisfaction of the pre-trigger condition requires a derivative of the sensed displacement parameter to be greater than a pre-trigger threshold, and wherein the output of the signal is further dependent on satisfaction of the pre-trigger condition.

The signal may be configured to control the damping force during the suspension restoring phase in dependence on a direction of actuator displacement, such that:
the damping force against a first actuator displacement direction associated with the suspension restoring phase depends on satisfaction of the condition; and
the damping force against a second actuator displacement direction not associated with the suspension restoring phase does not depend on satisfaction of the condition.

The control system may be configured to control the signal in dependence on vehicle speed, to reduce the signal if the vehicle speed is less than a lower threshold and/or to reduce the signal if the vehicle speed is greater than an upper threshold.

The control system may be configured to cease the controlling of the damping force when an exit condition associated with an end of the suspension restoring phase is satisfied.

According to an aspect of the invention there is provided an active suspension system comprising the control system and the actuator.

According to an aspect of the invention there is provided a vehicle comprising the control system or the active suspension system.

According to an aspect of the invention there is provided a method of controlling a damping force of an actuator of an active suspension system of a vehicle in response to an external disturbance of a wheel with which the actuator is associated, the method comprising:
receiving a sensed displacement parameter indicative of suspension displacement associated with the wheel;
determining whether a condition is satisfied, wherein satisfaction of the condition requires the sensed displacement parameter to indicate a transition from a suspension displacing phase associated with the external disturbance to a suspension restoring phase associated with the external disturbance, and wherein satisfaction of the condition depends on an amount of suspension displacement indicated by the sensed displacement parameter; and
outputting a signal to control the damping force to be greater, during the suspension restoring phase associated with the external disturbance, than if the condition is not satisfied, in dependence on satisfaction of the condition.

According to an aspect of the invention there is provided computer software that, when executed, is arranged to perform a method. According to a further aspect of the invention there is provided a non-transitory computer readable medium comprising computer readable instructions that, when executed by a processor, cause performance of any one or more of the methods described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of a control system;

FIG. 3 illustrates an example of a non-transitory computer-readable storage medium;

FIG. 4 illustrates an example of an active suspension system of a vehicle;

FIG. 5A illustrates an example of an external disturbance of a wheel of a vehicle;

FIG. 5B illustrates an example displacement time graph of suspension displacement associated with the external disturbance;

FIG. 6A illustrates an example pre-trigger threshold associated with suspension compression;

FIG. 6B illustrates an example pre-trigger threshold associated with suspension rebound;

FIG. 7 illustrates an example trigger threshold;

FIG. 8 illustrates an example damping force gain factor dependent on vehicle speed; and

FIG. 9 illustrates an example method.

### DETAILED DESCRIPTION

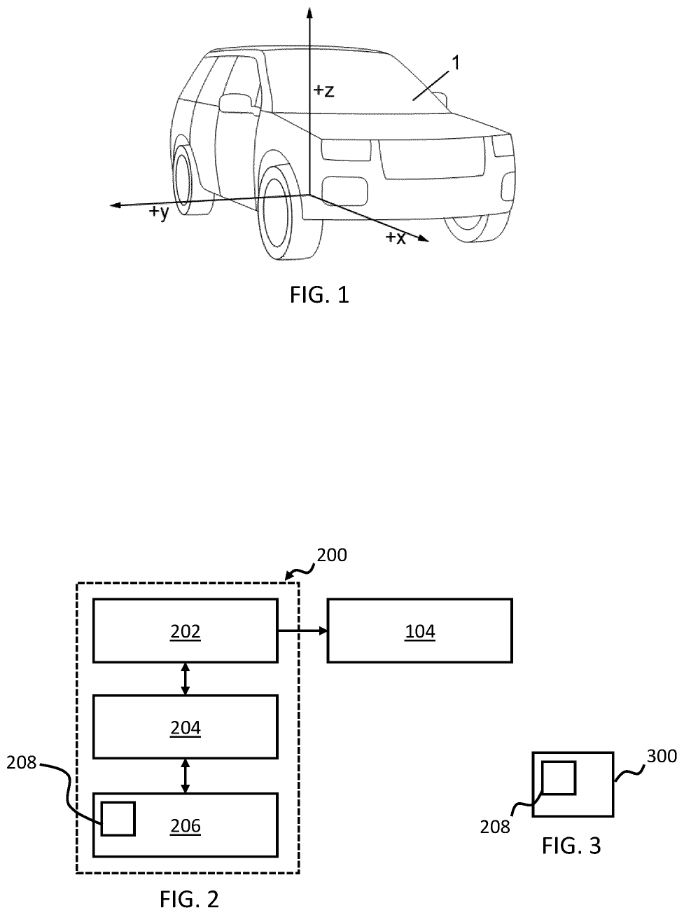

FIG. 1 illustrates an example of a vehicle 1 in which embodiments of the invention can be implemented. In some, but not necessarily all examples, the vehicle 1 is a passenger vehicle, also referred to as a passenger car or as an automobile. In other examples, embodiments of the invention can be implemented for other applications, such as commercial vehicles.

FIG. 1 is a front perspective view and illustrates a longitudinal x-axis between the front and rear of the vehicle 1 representing a centreline, an orthogonal lateral y-axis between left and right lateral sides of the vehicle 1, and a vertical z-axis. A forward/fore direction typically faced by a driver's seat is in the positive x-direction; rearward/aft is −x. A rightward direction as seen from the driver's seat is in the positive y-direction; leftward is −y. These are a first lateral direction and a second lateral direction.

The control system 200 of FIG. 2 comprises a controller 201. In other examples, the control system 200 may comprise a plurality of controllers on-board and/or off-board the vehicle 1. In some examples, a control system 200 or a controller 201 may be supplied as part of an active suspension system 104.

The controller 201 of FIG. 2 includes at least one processor 204; and at least one memory device 206 electrically coupled to the electronic processor 204 and having instructions (e.g. a computer program 208) stored therein, the at least one memory device 206 and the instructions configured to, with the at least one processor 204, cause any one or more of the methods described herein to be performed. The processor 204 may have an interface 202 such as an electrical input/output I/O or electrical input for receiving information and interacting with external components such as the active suspension system 104.

FIG. 3 illustrates a non-transitory computer-readable storage medium 300 comprising the instructions (computer software).

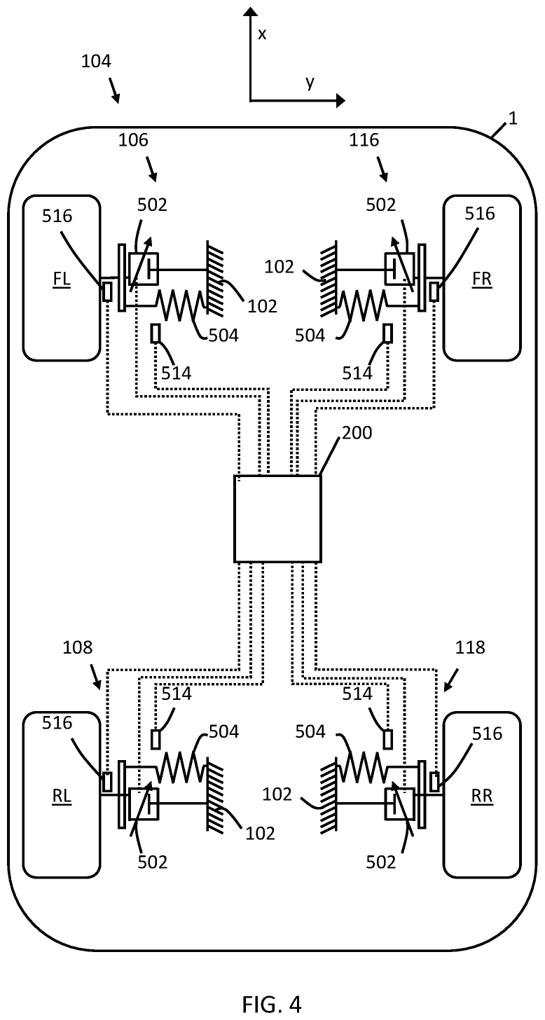

FIG. 4 illustrates an example implementation of the active suspension system 104. The illustrated active suspension system 104 is an adaptive suspension system. In other examples, the active suspension system 104 is a fully active suspension system.

The active suspension system 104 comprises front left active suspension 106 for a front left wheel FL, front right active suspension 116 for a front right wheel FR, rear left active suspension 108 for a rear left wheel RL, and rear right active suspension 118 for a rear right wheel RR. The active suspension for each wheel (e.g. quarter/corner) of the vehicle 1 may be individually controllable.

The active suspension for each corner of the vehicle 1 comprises an actuator 502.

In some examples, the actuator 502 is an active damper for an adaptive suspension system. The active damper may be solenoid/valve actuated. The active damper may be filled with magnetorheological fluid or another appropriate fluid.

In other examples, the actuator 502 is an actuator for a fully active suspension system. Energy can be added and/or extracted from the actuator 502 by pumping fluid and/or controlling valves to regulate fluid pressure to either side of the piston, to raise or lower the vehicle body 102.

A spring element 504 (e.g. coil or pneumatic) may be in equilibrium and acting in parallel with the actuator 502. The spring element 504 may be an active spring, such as an air spring, or a passive spring, such as a coil spring.

In order to control damping characteristics, the control system 200 may output a signal to control damping force. The signal may comprise a force request/demand that is dependent on sensed wheel travel velocity in a wheel travel axis.

Wheel travel (suspension displacement) may be sensed by a wheel-to-body displacement sensor 514 (suspension displacement sensor, ride height sensor), for example. The wheel-to-body displacement sensor 514 is placed somewhere on the active suspension and can sense the position of the wheel along an arc defined by suspension geometry. An example of a wheel-to-body displacement sensor 514 is a rotary potentiometer attached to a lever, wherein one end of the lever is coupled to the vehicle body 102, and the other end is coupled to a suspension link.

Wheel travel velocity can be indicated by the time-rate-of-change of wheel position. Wheel travel velocity can be sensed by differentiation of wheel travel and/or by integration of wheel acceleration from a wheel hub accelerometer 516. A hub accelerometer 516 can be provided for each wheel and coupled to the unsprung mass of the vehicle 1. Like the wheel-to-body displacement sensor 514, a hub accelerometer 516 can also be regarded as a suspension displacement-based sensor because hub acceleration in the z-axis is dependent on a rate of change of suspension displacement.

In some examples, the control system 200 more accurately determines the wheel travel and/or its associated derivatives by fusing information from the wheel-to-body displacement sensor 514 with information from hub accelerometers 516.

The above example refers to a hydraulic actuator 502, and in other embodiments the actuator may be an electromagnetic actuator or a pneumatic actuator, or the like.

In some examples, the force demand that is transmitted to the active suspension or a low-level controller thereof is an arbitrated force demand based on requests from various requestors and information from various sensors.

The control system 200 may be calibrated to provide a compromise between comfort and durability. If unexpected shocks should arise when in a most comfortable damping setting, the durability of the active suspension system 104 should be unaffected.

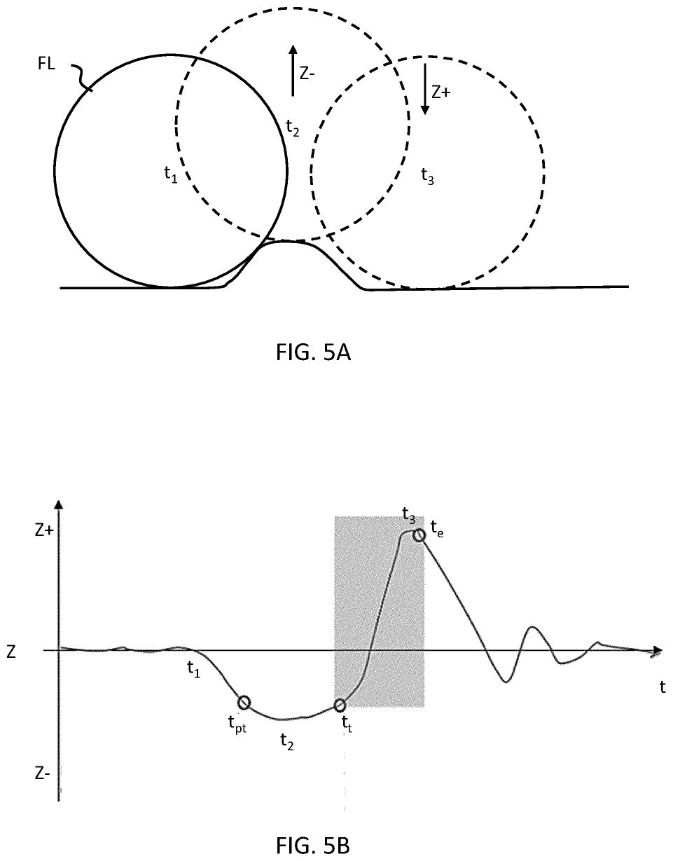

A control method for temporarily controlling damping force in response to a durability event is described herein with reference to FIGS. 5A-9. The control method relies primarily on reactive means rather than wholly predictive means, for optimal robustness. The control method relies on the fact that generally before a large suspension rebound event there is a large suspension compression event, such as a vehicle 1 driving over a speed bump or a humpback bridge. The control method also relies on the fact that generally before a large suspension compression event there is a large suspension rebound event, such as a vehicle 1 driving over a pothole or ditch.

By way of example, FIGS. 5A-5B illustrate an example of a wheel (e.g., FL) riding over an external disturbance, and illustrate an associated graph of the wheel. The graph represents suspension displacement (Z) against time (t). Compression is negative signed (Z−) and rebound is positive signed (Z+).

The external disturbance in this example comprises a hump such as a speed bump. This causes compression followed by rebound, as shown in FIG. 5B. In other examples, the external disturbance can comprise a dip such as a pothole. A pothole would cause extension (rebound) followed by compression.

Referring to FIG. 5A, initially at time t₁ when the wheel FL hits the speed bump the wheel FL moves into compression. At time t₂ as the wheel FL rolls over the speed bump the magnitude of the velocity decreases until the wheel starts extending again after the peak of the bump. At time t₃ the wheel FL leaves the speed bump and moves back towards compression, indicating the end of the durability event.

Referring to FIG. 5B, at time t₁ the suspension displacement starts to increase (in Z−) from zero. Zero represents the neutral undeflected height of the suspension. At time t₂ the suspension displacement is at peak compression and represents the point of reversal from compression to rebound. The period from times t₁ to t₂ therefore represents a suspension displacing phase associated with the external disturbance. At time t₃, the suspension displacement is at peak rebound following a first initial rebound. The first rebound comprises the release of energy from the initial compression. The period from times t₂ to t₃ therefore represents a suspension restoring phase associated the external disturbance of the wheel FL. The time t₂ represents the transition from the suspension displacing phase to the suspension restoring phase.

As can be seen in the graph of FIG. 5B, the suspension restoring phase has higher energy (steeper and greater peak) than the suspension displacing phase, in the case of rebound after compression. This creates a risk of an end of travel being reached. A worse scenario than that shown in FIG. 5A is one in which the bump is followed immediately by a pothole or similar drop, because the suspension of the wheel FL would have even more room to extend and gain kinetic energy.

The control method is configured to increase the damping force during the suspension restoring phase if the external disturbance is determined, during the preceding suspension displacing phase, to be a durability event.

In at least some examples, determining that an external disturbance is a durability event comprises determining whether a pre-trigger event has occurred (the preceding compression or rebound event). This comprises the control system 200 determining, at time tₚₜ during the suspension displacing phase, whether a pre-trigger condition is satisfied. The time tₚₜ of determining satisfaction of the pre-trigger condition is early enough that there is time for the actuator 502 to respond and late enough that there is time to ensure that the external disturbance is actually a durability event.

In dependence on the pre-trigger condition being satisfied, the control system 200 requests an increased damping force during at least part of the suspension restoring phase. The control system 200 increases the level of damping until the end of the durability event.

The increased damping force may be requested at a later trigger condition time tₜ than the time of determining that the pre-trigger condition is satisfied. The trigger condition time tₜ is at or just after the peak t₂, and during the suspension restoring phase. This ensures that the increased damping force is only applied when needed and is not applied at times when it is not needed.

The control system 200 may request an increased rebound rate (first actuator displacement direction) without requesting increased bump rate (second actuator displacement direction), in the case of detected rebound after compression. Similarly, the control system 200 may request an increased bump rate without requesting increased rebound rate, in the case of detected compression after rebound. Alternatively, the control system 200 may request increased overall damping force (generic to bump rate and rebound rate) in the case where bump rate and rebound rate are not separately controllable.

When an exit condition is satisfied at time tₑ, the control system 200 stops requesting the increased damping force. The exit condition is configured to occur with minimal delay to ensure that the actuator 502 can return to a standard comfort-focussed setting. The exit condition may be satisfied and acted on at or shortly after/before time t₃, and even before subsequent oscillations of the suspension (if underdamped).

The control method may work independently on each wheel, both in terms of detection and application of the damping.

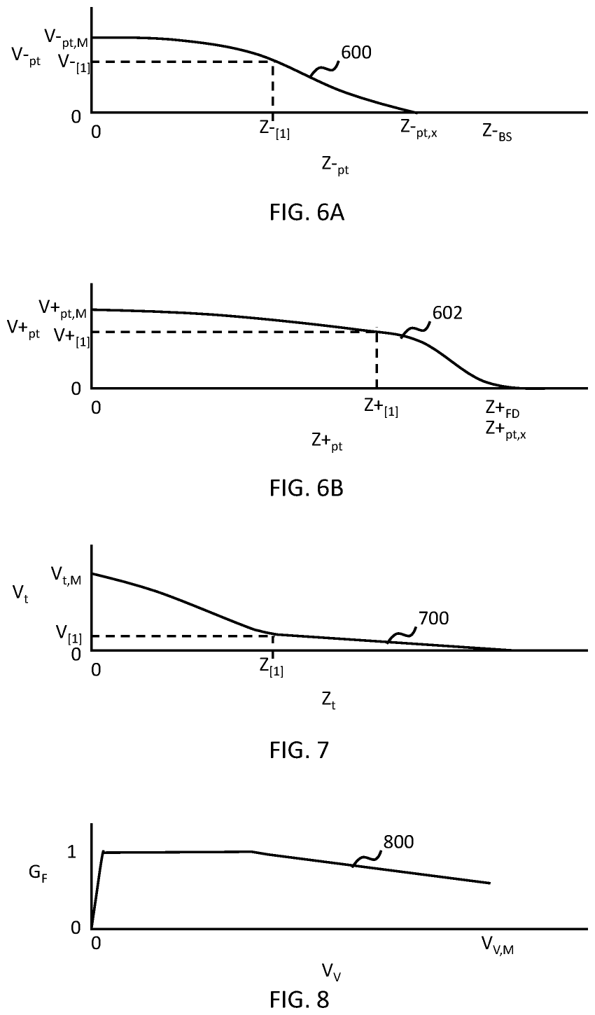

FIGS. 6A-7 are graphs illustrating examples of the pre-trigger condition and of the trigger condition for the control method, respectively. The functionality of the graphs may be implemented in the control system 200 in any appropriate manner, such as a control map with one or more thresholds.

First, FIGS. 6A-6B are described. They relate to the pre-trigger condition for detecting durability disturbances (such as a high-speed kerb/speed bump impact) and excluding non-durability disturbances (such as slow-speed rock-crawl or resonance-induced from gravel driving).

More specifically, they are graphs illustrating a derivative (rate of change) of suspension displacement on the y-axis and the amount (non-derivative/integral of y-axis) of suspension displacement on the x-axis.

The y-axis comprises suspension displacement velocity V (m/s), wherein FIG. 6A is V− (compression before rebound) and FIG. 6B is V+ (rebound before compression). The x-axis comprises suspension displacement Z (distance, m), wherein FIG. 6A is Z− (compression before rebound) and FIG. 6B is Z+(rebound before compression).

The subscript ‘pt’ represents pre-trigger, and ‘M’ is max. The labels Z−_{BS} and Z+_{FD} represent Z when the suspension is at full bump ‘BS’ (bottomed out against bump stop) or at full droop ‘FD’, respectively.

The origin [0, 0] represents V=0 and Z=0 where the opposing forces acting on the piston of the actuator 502 are balanced. Depending on the type of active suspension system 104, Z=0 could vary based on whatever ride height target is set by a body control module.

The plotted lines illustrate a pre-trigger threshold 600, 602 which is/are a function of V and Z, and therefore varies as Z increases. If a sensed operating point [V,Z] is greater than the pre-trigger threshold 600, 602, the pre-trigger threshold is exceeded. This satisfies the pre-trigger condition, or at least contributes to its satisfaction. Whether this is implemented as one combined pre-trigger threshold or as multiple separate pre-trigger thresholds/conditions is a matter for implementation.

In both FIGS. 6A and 6B, the pre-trigger threshold 600, 602 decreases for increasing values of Z. Therefore, as Z increases in magnitude, the value of V required to exceed the pre-trigger threshold is less in magnitude. This is because a given value of V (such as V_{[1]}) at a low value of Z does not necessarily indicate a durability event whereas that same value of V at a high value of Z indicates a durability event.

In FIGS. 6A-6B, but not necessarily all examples, the pre-trigger threshold 600, 602 decreases from a peak value V_{pt,M} at a first, low value of Z to a minimum value at a second, higher value of Z. The peak value may be the maximum value. The minimum value may optionally be substantially zero.

In at least some examples, the peak value of the pre-trigger threshold 600, 602 of FIGS. 6A-6B is a value greater than approximately two metres per second, with the exact value depending on calibration for the specific vehicle 1. In an example vehicle 1 weighing more than 300 kg per corner, the peak value is approximately three metres per second. Values of V above this peak value are guaranteed to represent a durability event. Values of V below this peak value may exceed the pre-trigger threshold if Z is high enough.

The amount of feedforward anticipation given by the pre-trigger depends on how high Z is when the pre-trigger threshold 600, 602 is exceeded. If Z is low, then the pre-trigger threshold is exceeded at the beginning of the suspension displacement phase. If Z is high, then the pre-trigger threshold is exceeded further along the suspension displacement phase.

Looking now to the minimum value, FIG. 6A illustrates the minimum value of V-pt Occurring at a value Z−_{pt,x} less than Z−_{BS}. In some examples, the value Z−_{pt,x} may coincide with suspension contact with a progressive bump stop, prior to full bottoming out.

In some examples, the minimum value of V−ₚₜ is substantially zero between the values of Z−ₚₜ,x and Z−_{BS}. Reaching this displacement Z−_{pt,x} or greater means that enough energy has been added to the suspension to be considered to satisfy the pre-trigger threshold 600, even if V≈0 m/s. In some examples, Z−_{pt,x} is a value of approximately two thirds of Z−_{BS}, or another value selected from the range approximately 50% to approximately 80% of Z−_{BS}.

FIG. 6A illustrates that the pre-trigger threshold 600 is nonlinear with respect to V− and Z−. The rate of decrease of the pre-trigger threshold 600 for an increasing value of Z− may follow an approximately sigmoidal shape. This ensures that for low values of Z−, the value of V− needs to be high. This improves control robustness for excluding non-durability events that may be encountered by an off-road type vehicle 1, such as rock crawl or gravel driving. However, it would be appreciated that in other examples, the shape could be another nonlinear shape or could even be linear.

Turning now to FIG. 6B, which represents V+ and Z+ (rebound before compression), the pre-trigger threshold 602 has a different shape. Although the peak value V+_{pt,M} may optionally be the same or similar to that of FIG. 6A, the function may be longer-tailed. The minimum value of V+ₚₜ occurs at Z+_{pt,x}, wherein Z+_{pt,x} is greater than Z−_{pt,x}. In some examples, Z+_{pt,x} is approximately equal to Z+_{FD}. Therefore, even at values of Z close to full droop, the value of V+needed to exceed the pre-trigger threshold 602 may be greater than the equivalent value V− needed to exceed the pre-trigger threshold 600. The shape of the curve of FIG. 6B may again be approximately sigmoidal but generally stretched in the x-axis, or may be another shape.

Refer for example to the plotted values [V+_{[1]}, Z+_{[1]}] in FIG. 6A and [V−_{[1]}, Z−_{[1]}] in FIG. 6B, where [1] is an ordinate between the peak and minimum values. If V+_{[1]}=V−_{[1]} (such as two-thirds of peak value), then Z+_{[1]}>Z−_{[1]}. Likewise, if instead Z+_{[1]}=Z−_{[1]}, then V+_{[i]}>V−_{[1]}.

In an alternative example, the pre-trigger thresholds 600, 602 for compression before rebound (FIG. 6A) and for rebound before compression (FIG. 6B) are the same as each other (but opposite signs), rather than different shaped/scaled functions as illustrated. In a further alternative example, a pre-trigger threshold 602 for rebound before compression (FIG. 6B) is omitted because in some vehicles, rebound before compression is less energetic than compression before rebound.

In some, but not necessarily all examples, control robustness against sensor noise may be improved by requiring the pre-trigger threshold 600/602 to be exceeded multiple times within a sampling window. The control system 200 may require the pre-trigger threshold 600/602 to be exceeded for every sample within the sampling window. The control system 200 may require the pre-trigger threshold 600/602 to be exceeded N times in a row. In an example implementation, the value of N is selected from the range three samples to ten samples. The size of the sampling window is a value less than 50 milliseconds, such as approximately 20 milliseconds. The number of samples within the sampling window depends on the sampling frequency of the suspension displacement sensor 514 and/or hub accelerometer 516. For example, N=5 for a sampling frequency of 5 milliseconds and a sampling window of 20 milliseconds.

Referring now to FIG. 7, the control system 200 is further configured to determine whether a trigger condition is satisfied, for triggering the increased damping force. Satisfaction of the trigger condition requires the sensed displacement parameter to indicate a transition from the suspension displacing phase to the suspension restoring phase.

One way to detect the transition is to detect whether Z exceeds a threshold, to confirm that Z has reached a high enough value to be designated as a durability event. However, the illustrated approach in FIG. 7 offers improved control robustness against sensor noise and against false positive satisfaction of the pre-trigger condition. FIG. 7 relies upon the same terminology/definitions as FIGS. 6A, 6B.

According to FIG. 7, the trigger threshold 700 comprises a function of [V, Z], for reactively detecting the start of the suspension restoring phase. The variables V, Z may be as defined earlier. Whether this is implemented as one combined trigger threshold 700 or as multiple separate trigger thresholds/conditions is a matter for implementation. FIG. 7 represents one unsigned graph [V, Z] although in other examples the trigger condition could be different for [V+, Z+] and [V−, Z−].

To confirm that reversal has occurred, the trigger condition may require V to have the opposite sign than the sign of the value of V that satisfied the pre-trigger condition. For example, in the case of compression before rebound, the pre-trigger condition may be satisfied by V- and therefore the trigger condition may require detection of V+(rebound).

In FIG. 7, the trigger threshold 700 decreases for increasing values of Z. Therefore, as Z increases, the value of V required to exceed the trigger threshold 700 is less. This is because a given value of V (such as V_{[1]}) at a low value of Z does not necessarily indicate a durability event—high values of V can be encountered due to normal resonance such as when driving on gravel. By contrast, the same value of V at a high value of Z indicates a durability event.

In FIG. 7, but not necessarily all examples, the trigger threshold 700 decreases from a peak value V_{t,M} at a first, low value of Z to a minimum value at a second, higher value of Z. The peak value may be the maximum value. The minimum value may optionally be substantially zero.

In at least some examples, the peak value of the trigger threshold 700 of FIG. 7 is a value greater than approximately two metres per second, with the exact value depending on calibration for the specific vehicle 1. In an example vehicle 1 weighing more than 300 kg per corner, the peak value is approximately three metres per second. Values of V above this peak value are guaranteed to represent a durability event. Values of V below this peak value may exceed the trigger threshold 700 if Z is high enough.

The amount of feedforward anticipation given by the trigger condition depends on how high Z is when the trigger threshold 700 is exceeded. If Z is low, then the trigger threshold 700 is exceeded at the very beginning of the suspension restoring phase. If Z is high, then the pre-trigger threshold 600/602 is exceeded further along the suspension restoring phase.

Looking now to the minimum value, FIG. 7 illustrates the minimum value of Vₜ occurring at a value Zₜ approximately equal to Z at full droop/full bump. In some examples, the minimum value is substantially zero.

FIG. 7 illustrates that the trigger threshold 700 may be nonlinear with respect to V and Z. The rate of decrease of the trigger threshold 700 for an increasing value of Z may be initially high and then lower. This ensures that for low values of Z, the value of V needs to be high. This improves control robustness for excluding non-durability events that may be encountered by an off-road type vehicle 1 implementing the control method, such as rock crawl or gravel driving. However, it would be appreciated that in other examples, the shape could be another nonlinear shape or could even be linear.

In an example, the trigger threshold 700 falls to less than or equal to one metre per second of V by a value of Z selected from the range approximately 20% to approximately 60% of a bump stop or full droop value.

In some, but not necessarily all examples, the trigger condition may implement a sampling window equivalent to that described above for the pre-trigger condition.

In some, but not necessarily all examples, the trigger condition may further require the trigger threshold 700 to have been exceeded before expiry of a timer. The timer may be initiated in response to satisfaction of the pre-trigger condition. The timer ensures that the trigger condition and the pre-trigger condition relate to the same external disturbance of the wheel, such as the same speed bump. The timer may have an expiry duration having a value selected from the range 100 milliseconds to five seconds, such as approximately two seconds. If the timer expires before satisfaction of the trigger condition, then the damping force is not increased in response to satisfaction of the trigger condition.

Once the entry conditions (pre-trigger condition and trigger condition) have been satisfied in sequence, the control system 200 outputs the signal to control the damping force to be greater, during the rest of the suspension restoring phase, than if the trigger condition is not satisfied.

As stated before, the damping force may be increased for bump rate but not rebound rate if the suspension restoring phase comprises compression, and may be increased for rebound rate but not bump rate if the suspension restoring phase comprises rebound. This ensures that the actuator 502 is not too stiff if a sudden unexpected disturbance against the restoring direction occurs during the suspension restoring phase, such as a pothole at the end of a speed bump.

When determining the amount of increased damping force, the signal may be applied as a predetermined value. The signal could be applied in any appropriate way such as an overriding signal, an offset, or a high priority request for the arbitrator function. In some examples, the signal is a controlled variable based on feedback, rather than a predetermined value.

In some examples, the increased damping force may be scaled by another variable. In an implementation, the signal may be scaled by a gain between 0 and 1, wherein the gain depends on the other variable. The other variable may comprise vehicle speed (V_{V}), for example. FIG. 8 shows an example of how vehicle speed can affect the gain, to improve control robustness and/or performance.

FIG. 8 illustrates the gain G having a low value such as zero, at a vehicle speed of approximately zero. This is because a durability event cannot occur when the vehicle 1 is stationary. The gain may increase to a value greater than 0.5 of its full value, such as G=1, when the vehicle speed reaches a minimum/lower threshold selected from the range 5 kilometres per hour to 15 kilometres per hour. The peak gain is then maintained across most of the vehicle's speed range. In some examples, at vehicle speeds greater than an upper threshold, the upper threshold being a value greater than 40 metres per second, the gain may reduce to improve damping consistency on bumpy race tracks or the like. The gain may be lower at V_{V,M} (Vmax) than at vehicle speeds below the upper threshold.

The control system 200 is configured to cease the increased damping force when an exit condition is satisfied. The exit condition is configured to indicate an end of the suspension restoring phase. The purpose of the exit condition is to ensure that the increase damping force is only applied for the single durability event, so that the damping force can return to an arbitrated skyhook/comfort setting as quickly as possible.

The exit condition can comprise at least one exit condition threshold, such that the exit condition is satisfied when a monitored variable associated with the active suspension system 104 of the wheel is below the exit condition threshold, towards a neutral undeflected rest state [V=0, Z=0].

In some examples, the at least one exit condition threshold comprises a threshold of V and/or a threshold of Z. When V falls below the V threshold, and/or when Z falls below the Z threshold, the exit condition is satisfied. Additionally, or alternatively, the above-mentioned timer from the pre-trigger condition (or another timer from the trigger condition) may satisfy the exit condition.

If more than one of the above examples are employed, an ‘OR’ condition could mean that whichever exit condition threshold/timer expiry is passed first satisfies the exit condition. Alternatively, an ‘AND’ condition could mean that both exit condition thresholds need to be passed first to satisfy the exit condition.

In an implementation, the V threshold is a low value, wherein the low value is less than approximately 0.7 m/s, such as approximately 0.4 m/s. In an implementation, the Z threshold is a low value, wherein the low value is less than approximately 0.03 metres, such as approximately 0.015 metres.

In some examples, when the exit condition is satisfied the damping force is reduced progressively, for example to approximately zero, to return to normal damping operation. Reducing progressively can comprise, for example reducing the gain over a period having a value greater than approximately 0.4 seconds. In some examples, the value of the period is less than approximately ten seconds. In an implementation, the value of the period is approximately 0.6 seconds. The progressive reduction can comprise a linear reduction or any other appropriate reduction function.

The above examples of the pre-trigger, trigger and exit conditions are functions of V and Z. In a further example (not illustrated), one or more of the conditions are a function of suspension displacement acceleration A (m/s²) and Z, which would improve feedforward control. By contrast, the illustrated functions of V and Z provide improved control robustness, because it has been found during experimentation to better able to exclude normal, non-durability events such as normal resonance which is associated with high wheel acceleration but low displacement.

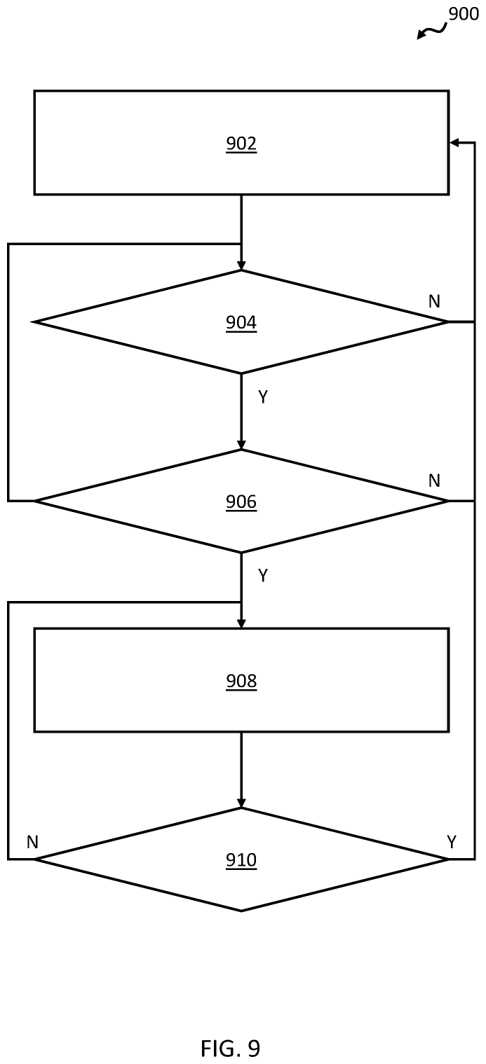

FIG. 9 illustrates an example method 900 summarising the above control method as a flowchart. The method 900 is implemented by the control system 200.

The method 900 comprises, at block 902, receiving a sensed displacement parameter indicative of suspension displacement associated with the wheel. The sensed displacement parameter may comprise wheel travel sensed by the wheel-to-body displacement sensor, or an equivalent thereof.

The term ‘wheel travel’ should be understood in a broad manner. It does not limit the location of the wheel-to-body displacement sensor to being on the wheel or wheel hub, and further does not limit the sensed displacement parameter to a parameter that has undergone motion ratio conversions.

Block 904 comprises determining whether a condition (pre-trigger condition) is satisfied, during a suspension displacing phase associated with the external disturbance, wherein satisfaction of the pre-trigger condition requires a derivative of the sensed displacement parameter (V) to be above a threshold, and wherein the threshold depends on an amount of displacement (Z) indicated by the sensed displacement parameter. See FIGS. 6A-6B and the accompanying description for examples.

If block 904 is not satisfied, the method 900 loops back to block 902 to continue receiving the sensed displacement parameter. If block 904 is satisfied, the method 900 proceeds to block 906.

Block 906 comprises determining whether a condition (trigger condition) is satisfied, wherein satisfaction of the trigger condition requires the sensed displacement parameter to indicate a transition from a suspension displacing phase associated with the external disturbance to a suspension restoring phase associated with the external disturbance, and wherein satisfaction of the trigger condition depends on an amount of suspension displacement (Z) indicated by the sensed displacement parameter, and may further depend on the derivative thereof (V). See FIG. 7 and the accompanying description for examples.

If block 906 is not satisfied, the method 900 loops back to block 904 to continue monitoring whether the trigger condition is satisfied. If the timer expires, the method 900 may loop back to block 902. If block 906 is satisfied, the method 900 proceeds to block 908.

Block 908 comprises outputting a signal to control the damping force to be greater, during a suspension restoring phase associated with the external disturbance, than if the condition is not satisfied, in dependence on satisfaction of the condition(s). See FIG. 8 and the accompanying description for examples.

Block 910 comprises determining whether an exit condition is satisfied, wherein satisfaction of the exit condition is dependent on the sensed displacement parameter indicating an end of the suspension restoring phase, comprising the sensed displacement parameter (V and/or Z) being below at least one exit condition threshold. The exit condition may further depend on the timer.

If block 910 is satisfied, the method 900 terminates block 908 (terminates the signal requesting the increased damping force) and loops back to block 902 to continue receiving the sensed displacement parameter, to monitor for the next external disturbance. Block 908 continues for as long as block 910 is not satisfied.

The method 900 may work independently for each wheel FL, FR, RL, RR (corner) of the vehicle 1, both in terms of detection and the application of the increased damping force. That is, at a given moment in time, one actuator 502 for one wheel may receive an increased damping force (block 908) whereas another actuator 502 for another wheel may not receive an increased damping force (block 908).

It is believed that the pre-trigger condition, the trigger condition, and the exit condition may be independently patentable in their own right, without depending upon the presence of or full functionality of all the other conditions.

For purposes of this disclosure, it is to be understood that the controller(s) described herein can each comprise a control unit or computational device having one or more electronic processors. A vehicle and/or a system thereof may comprise a single control unit or electronic controller or alternatively different functions of the controller(s) may be embodied in, or hosted in, different control units or controllers. A set of instructions could be provided which, when executed, cause said controller(s) or control unit(s) to implement the control techniques described herein (including the described method(s)). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on one or more electronic processors, optionally the same one or more processors as the first controller. It will be appreciated, however, that other arrangements are also useful, and therefore, the present disclosure is not intended to be limited to any particular arrangement. In any event, the set of instructions described above may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

It will be appreciated that various changes and modifications can be made to the present invention without departing from the scope of the present application.

The blocks illustrated in FIG. 9 may represent steps in a method and/or sections of code in the computer program 208. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A control system configured to control a damping force of an actuator of an active suspension system of a vehicle in response to an external disturbance of a wheel with which the actuator is associated, the control system comprising one or more controllers, wherein the control system is configured to:
receive a sensed displacement parameter indicative of suspension displacement associated with the wheel;
determine whether a condition is satisfied, wherein satisfaction of the condition requires the sensed displacement parameter to indicate a transition from a suspension displacing phase associated with the external disturbance to a suspension restoring phase associated with the external disturbance, and wherein satisfaction of the condition depends on an amount of suspension displacement indicated by the sensed displacement parameter; and
output a signal to control the damping force to be greater, during the suspension restoring phase associated with the external disturbance, than if the condition is not satisfied, in dependence on satisfaction of the condition.

2. The control system of claim 1, wherein detecting the transition is dependent on a change of sign of a derivative of the sensed displacement parameter from a first sign associated with the suspension displacing phase to a second sign associated with the suspension restoring phase.

3. The control system of claim 2, wherein detecting the transition is dependent on the derivative, having the second sign, being greater than a threshold.

4. The control system of claim 3, wherein the threshold depends on the amount of suspension displacement indicated by the sensed displacement parameter.

5. The control system of claim 4, wherein the threshold decreases as the amount of suspension displacement indicated by the sensed displacement parameter increases.

6. The control system of claim 5, wherein the threshold falls to less than or equal to one metre per second by a value of the amount of suspension displacement selected from a range from approximately 20% to approximately 60% of a bump stop or full droop value.

7. The control system of claim 3, wherein the threshold is further dependent on whether the second sign is positive or negative, such that for at least some values of the amount of suspension displacement the threshold is lower if the second sign indicates a suspension compression direction than if the sign indicates a suspension extension direction.

8. The control system of claim 3, wherein the condition requires the threshold to be exceeded multiple times within a sampling window.

9. The control system of claim 1, configured to determine whether a pre-trigger condition is satisfied, during the suspension displacing phase, wherein satisfaction of the pre-trigger condition requires a derivative of the sensed displacement parameter to be greater than a pre-trigger threshold, and wherein the output of the signal is further dependent on satisfaction of the pre-trigger condition.

10. The control system of claim 1, wherein the signal is configured to control the damping force during the suspension restoring phase in dependence on a direction of actuator displacement, such that:
the damping force against a first actuator displacement direction associated with the suspension restoring phase depends on satisfaction of the condition; and
the damping force against a second actuator displacement direction not associated with the suspension restoring phase does not depend on satisfaction of the condition.

11. The control system of claim 1, configured to control the signal in dependence on vehicle speed, to reduce the signal if the vehicle speed is less than a lower threshold and/or to reduce the signal if the vehicle speed is greater than an upper threshold.

12. The control system of claim 1, configured to cease controlling of the damping force when an exit condition associated with an end of the suspension restoring phase is satisfied.

13. An active suspension system comprising the control system of claim 1.

14. A vehicle comprising the control system of claim 1.

15. A method of controlling a damping force of an actuator of an active suspension system of a vehicle in response to an external disturbance of a wheel with which the actuator is associated, the method comprising:
receiving a sensed displacement parameter indicative of suspension displacement associated with the wheel;
determining whether a condition is satisfied, wherein satisfaction of the condition requires the sensed displacement parameter to indicate a transition from a suspension displacing phase associated with the external disturbance to a suspension restoring phase associated with the external disturbance, and wherein satisfaction of the condition depends on an amount of suspension displacement indicated by the sensed displacement parameter; and
outputting a signal to control the damping force to be greater, during the suspension restoring phase associated with the external disturbance, than if the condition is not satisfied, in dependence on satisfaction of the condition.

16. Computer software that, when executed by a processor, causes the processor to perform the method according to claim 15.

17. A vehicle comprising the active suspension system of claim 13.
